(19) United States
(12) Patent Application Publication
(10) Pub. No.: US 2024/0354174 A1
(43) Pub. Date: Oct. 24, 2024

(54) DATA CONSTRUCTION SYSTEM AND DATA CONSTRUCTION METHOD

(71) Applicants: Digiwin Software Co., Ltd, Shanghai (CN); DATA SYSTEMS CONSULTING CO., LTD., New Taipei City (TW)

(72) Inventors: Lei Feng, Shanghai (CN); Guoxin Sun, Shanghai (CN)

(73) Assignees: Digiwin Software Co., Ltd, Shanghai (CN); DATA SYSTEMS CONSULTING CO., LTD., New Taipei City (TW)

(21) Appl. No.: 18/349,967

(22) Filed: Jul. 11, 2023

(30) Foreign Application Priority Data
Apr. 20, 2023 (CN) 202310425257.0

(51) Int. Cl. G06F 9/54; G06F 8/30

(52) U.S. Cl. CPC G06F 9/541; G06F 8/30; G06F 9/547

(57) ABSTRACT

A data construction system and a data construction method are provided. The data construction system includes a memory and a processor. The memory stores a data automatic construction component. The processor executes the data automatic construction component to obtain a call request instruction and a data source from a computer device. The data automatic construction component determines input metadata and an API to be called in a business system according to the call request instruction and the data source, and the data automatic construction component reads a server according to the API and the input metadata to obtain a mapping rule and a metadata set. The data automatic construction component uses the data source to construct an input parameter according to the mapping rule and the metadata set, and outputs the input parameter to the API, so that the API responds corresponding business data to the computer device.

### CROSS-REFERENCE TO RELATED APPLICATION

This application claims the priority benefit of China application serial no. 202310425257.0, filed on Apr. 20, 2023. The entirety of the above-mentioned patent application is hereby incorporated by reference herein and made a part of this specification.

### BACKGROUND

### Technical Field

The invention relates to an automatic data generation technology, and more particularly, to a data construction system and a data construction method.

### Description of Related Art

In a service allocation of application programming interfaces (APIs) of a business system, since a user calls a service to the business system to obtain business data, it is required to input a corresponding parameter and a structure thereof to the corresponding application programming interface in the business system, if the input parameter or the structure thereof does not meet requirements on data format and data content, the user needs to modify a calculation process of the parameter and a restructuring method of the structure through manual design or adjustment. In addition, the user need to assemble data into the input parameter that meet the requirements of the data format and data content through hard coding, so that they may be used to call the service.

### SUMMARY

The invention relates to a data construction system and a data construction method, which may automatically construct an input parameter of an application programming interface to be called.

According to an embodiment of the invention, the data construction system of the invention includes a memory and a processor. The memory is configured to store a data automatic construction component. The processor is connected to a computer device, a server, and a business system, and is configured to execute the data automatic construction component and obtain a call request instruction and a data source from the computer device. The data automatic construction component determines input metadata and an application programming interface to be called in the business system according to the call request instruction and the data source, and the data automatic construction component reads the server according to the application programming interface and the input metadata to obtain a mapping rule and a metadata set. The data automatic construction component uses the data source to construct an input parameter according to the mapping rule and the metadata set, and the data automatic construction component outputs the input parameter to the application programming interface, so that the application programming interface responds corresponding business data to the computer device according to the input parameter.

According to an embodiment of the invention, the data construction method of the invention includes the following. A data automatic construction component is executed by a processor, and a call request instruction and a data source are obtained from a computer device. Input metadata and an application programming interface to be called in a business system are determined by the data automatic construction component according to the call request instruction and the data source. The server is read by the data automatic construction component according to the application programming interface and the input metadata to obtain a mapping rule and a metadata set. The data source is used by the data automatic construction component to construct an input parameter according to the mapping rule and the metadata set. The input parameter is output to the application programming interface by the processor, so that the application programming interface responds corresponding business data to the computer device according to the input parameter.

Based on the above, the data construction system and the data construction method of the invention are adapted to automatically determine and obtain the mapping rule and the metadata set according to the call request instruction, and use the related data in the data source according to the mapping rule and the metadata set to construct the input parameter of the application programming interface to be called.

In order for the aforementioned features and advantages of the invention to be more comprehensible, several embodiments accompanied with drawings are described in detail as follows.

### BRIEF DESCRIPTION OF THE DRAWINGS

FIG. 1 is a system schematic diagram of a data construction system according to an embodiment of the invention.

FIG. 2 is a flowchart of a data construction method according to an embodiment of the invention.

FIG. 3 is a schematic diagram of related components and units of an embodiment of the invention.

FIG. 4A to FIG. 4C are flowcharts of a data construction method according to an embodiment of the invention.

FIG. 5A is a schematic diagram of a data source according to an embodiment of the invention.

FIG. 5B is a schematic diagram of a mapping rule according to an embodiment of the invention.

FIG. 5C is a schematic diagram of input metadata according to an embodiment of the invention.

FIG. 5D is a schematic diagram of a parameter mapping result list according to an embodiment of the invention.

FIG. 5E is a schematic diagram of an input parameter according to an embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

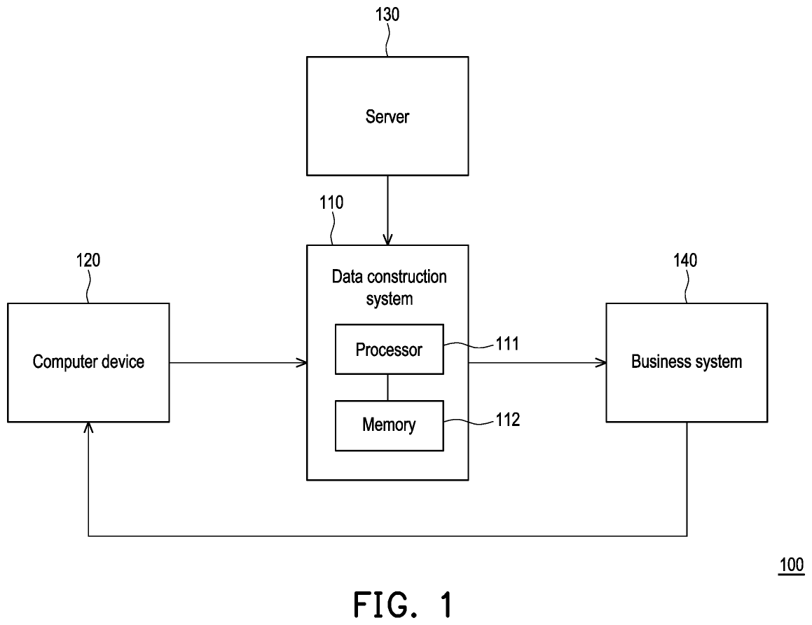

FIG. 1 is a system schematic diagram of a data construction system according to an embodiment of the invention. Referring to FIG. 1, a system 100 includes a data construction system 110, a computer device 120, a server 130 and a business system 140. The system 100 is a specific implementation scenario and a system framework corresponding to the data construction system 110. In the embodiment, the computer device 120 is connected to the data construction system 110 and the business system 140. The data construction system 110 is further connected to the server 130 and the business system 140. In the embodiment, the data construction system 110, the server 130 and the business system 140 may be set in cloud, and the data construction system 110 and the business system 140 may be realized by another server. Alternatively, in an embodiment, the data construction system 110, the server 130, and the business system 140 may also be set in a same server. In the embodiment, the data construction system 110, the computer device 120, the server 130 and the business system 140 may be connected through wired and/or wireless communication.

In the embodiment, the data construction system 110 includes a processor 111 and a memory 112. The processor 111 is electrically connected to the memory 112. In the embodiment, the processor 111 may be a system on a chip (SOC), or may include, for example, a central processing unit (CPU) or other programmable general-purpose or special-purpose microprocessor, digital signal processor (DSP), programmable controller, application specific integrated circuits (ASIC), programmable logic device (PLD), other similar processing devices, or a combination of these devices. In the embodiment, the memory 112 may be, for example, a dynamic random access memory (DRAM), a flash memory or a non-volatile random access memory (NVRAM), etc. In the embodiment, the memory 112 may be used to store related components and units for the processor 111 to read and execute, and the memory 112 may also temporarily store related data required or generated during a data construction process. In addition, the computer device 120, the server 130, and the business system 140 may all have, for example, the above-mentioned processor and memory.

In the embodiment, the computer device 120 may be, for example, a laptop computer, a desktop computer, a tablet computer, a smart phone or a related electronic device. A user may operate the computer device 120 to generate a call request instruction, and provide the call request instruction to the data construction system 110, and the data construction system 110 may perform automatic data construction according to the call request instruction to generate a corresponding input parameter. In the embodiment, the server 130 is configured to implement a kind of database, and is configured to store a plurality of mapping rules and related data of a plurality of metadata sets for the access of the data construction system 110. In the embodiment, the business system 140 is used to provide a plurality of services of a plurality of application programming interfaces (API), so that the data construction system 110 may decide to call the corresponding API according to the input parameter. The business system 140 may be, for example, an enterprise resource planning (ERP) system, a manufacturing execution system (MES), a human resources management system (HRMS) or a financial management system (FMS), which is not limited by the invention.

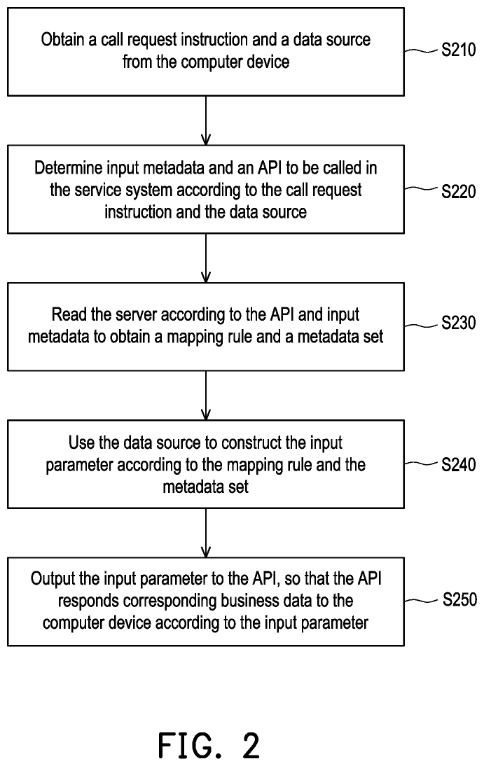

FIG. 2 is a flowchart of a data construction method according to an embodiment of the invention. Referring to FIG. 1 and FIG. 2, the data construction system 110 may execute following steps S210-S230 to achieve automatic data construction. In the embodiment, the user may operate the computer device 120 to determine a service of an API to be called, and the computer device 120 generates a corresponding call request instruction and outputs it to the data construction system 110. In step S210, the data construction system 110 may obtain the call request instruction and a corresponding data source from the computer device 120. In the embodiment, the call request instruction may include an API name of the API to be called. The data source is a data source for constructing input parameters, and may include metadata provided by the computer device 120 or the server 130 and/or source metadata generated by other APIs, and may be temporarily stored in the memory 112. In step S220, the data construction system 110 may determine input metadata and an API to be called in the service system 140 according to the call request instruction and the data source. In the embodiment, the input metadata is configured to describe a data structure definition of the input parameter.

In step S230, the data construction system 110 may read the server 130 according to the API and input metadata to obtain a corresponding mapping rule and a metadata set. In the embodiment, the metadata set may include the metadata and the source metadata. The mapping rule may be used to represent a mapping relationship between data in the data source and a parameter structure of the input parameter. In step S240, the data construction system 110 may use the data source to construct the input parameter according to the mapping rule and the metadata set. In the embodiment, the input parameter may be a kind of data with a form structure, and includes a plurality of fields. In step S250, the data construction system 110 may output the input parameter to the API in the business system 140, and the API may respond corresponding business data to the computer device 120 according to the input parameter. Therefore, the data construction system 110 may automatically construct the input parameter according to the call request instruction.

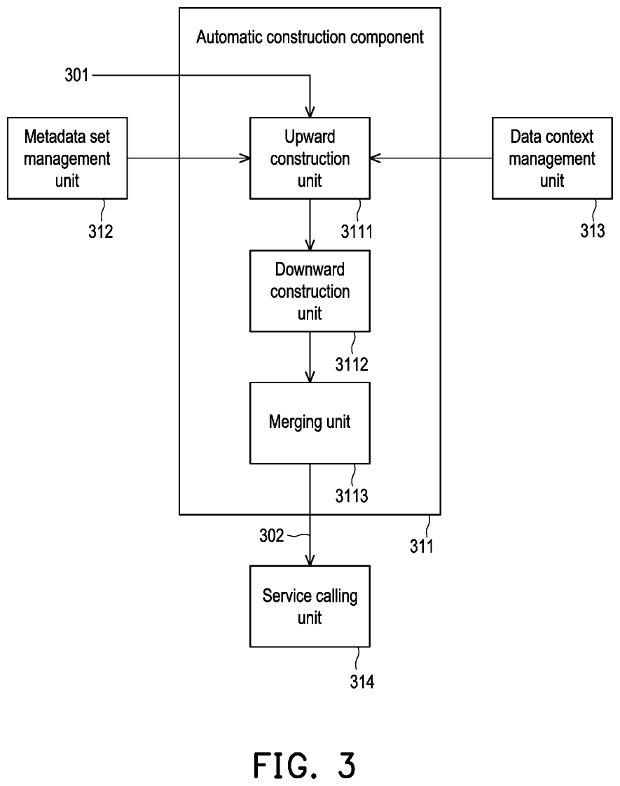

FIG. 3 is a schematic diagram of related components and units of an embodiment of the invention. Referring to FIG. 1 and FIG. 3, in the embodiment, the memory 112 of the data construction system 110 may store related algorithms and data of an automatic construction component 311, a metadata set management unit 312, a data context management unit 313 and a service calling unit 314 as shown in FIG. 3. In the embodiment, the automatic construction component 311, the metadata set management unit 312, the data context management unit 313, and the service calling unit 314 may be implemented by using program languages such as JavaScript object notation (JSON), extensible markup language (XML) or YAML, etc., but the invention is not limited thereto. In the embodiment, the automatic construction component 311 may further include an upward construction unit 3111, a downward construction unit 3112 and a merging unit 3113.

In the embodiment, the processor 111 may execute the metadata set management unit 312 to manage the metadata set. The processor 111 may execute the data context management unit 313 to manage context data provided (returned) by other APIs, where the context data may be a metadata set. In the embodiment, the upward construction unit 3111 may obtain the metadata set from the metadata set management unit 312 and the context data from the data context management unit 313 according to the API name in a call request instruction 301. The upward construction unit 3111 may search the server 130 according to the API to be called and the input metadata to obtain the mapping rule and the metadata set. In this way, the upward construction unit 3111 may construct an outer structure corresponding to each root key field in an input parameter 302 according to the mapping rule, the metadata set, the context data and the input metadata. Then, the upward construction unit 3111 may transfer the existing metadata, source metadata and mapping rule to the downward construction unit 3112. The downward construction unit 3112 may construct an inner structure corresponding to each root key field in the input parameter according to the mapping rule, the metadata set, the context data and the input metadata. Finally, the merging unit 3113 may merge all of the constructed root key fields to generate the input parameter 302 and provide it to the service calling unit 314. Therefore, the processor 111 may execute the service calling unit 314 to call the API to be called in the service system 140 according to the input parameter 302. In this way, the called API may respond corresponding service data to the computer device 120 according to the input parameter.

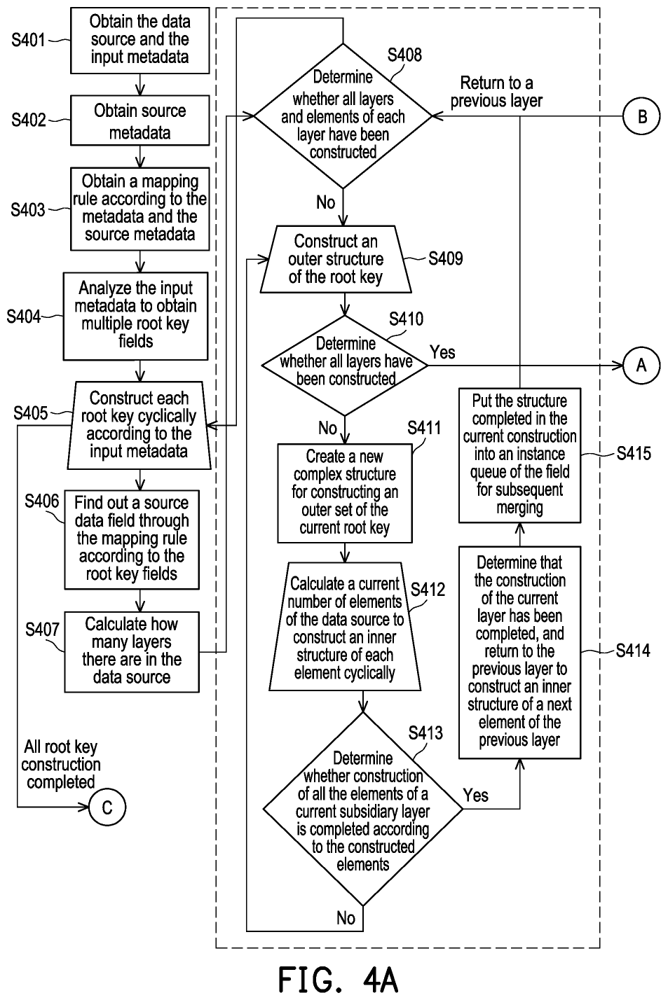

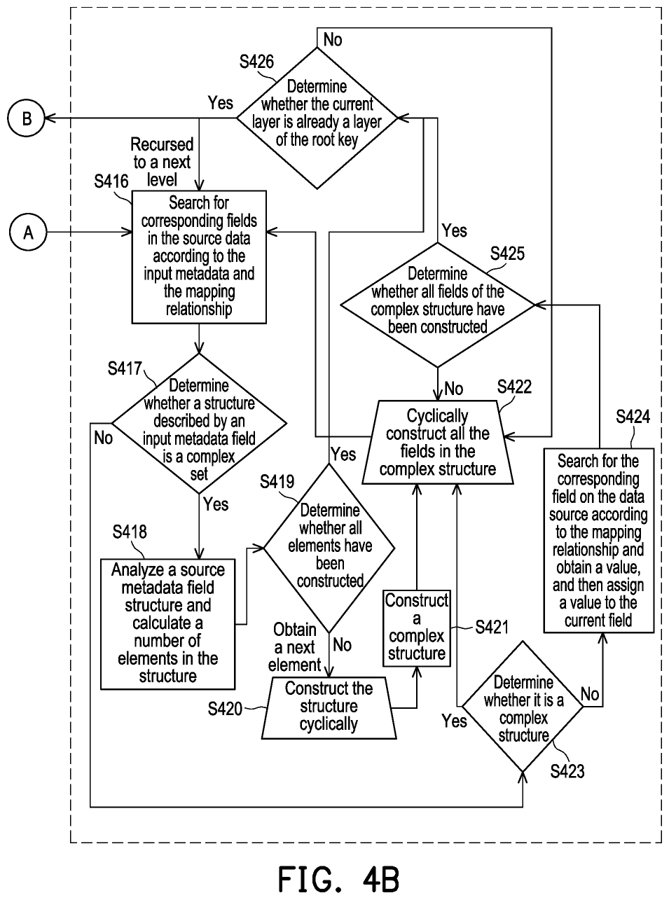

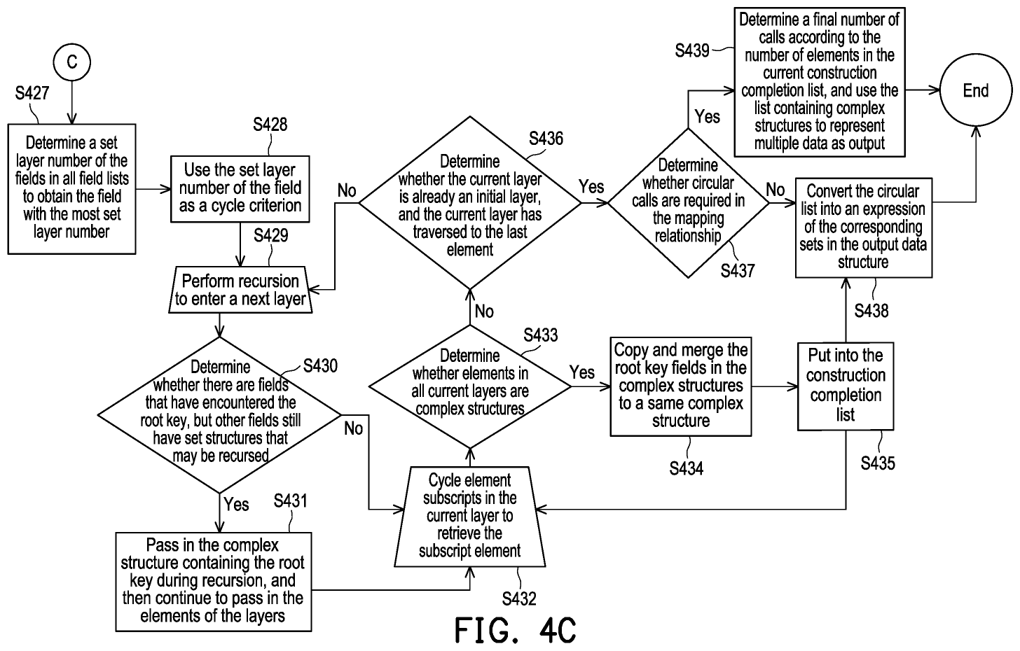

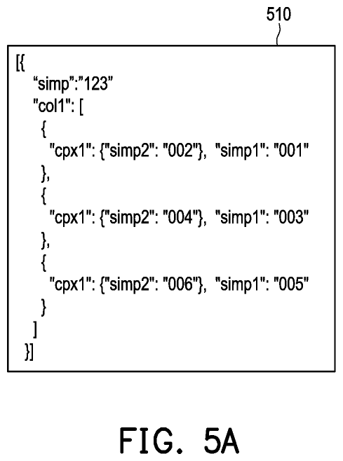

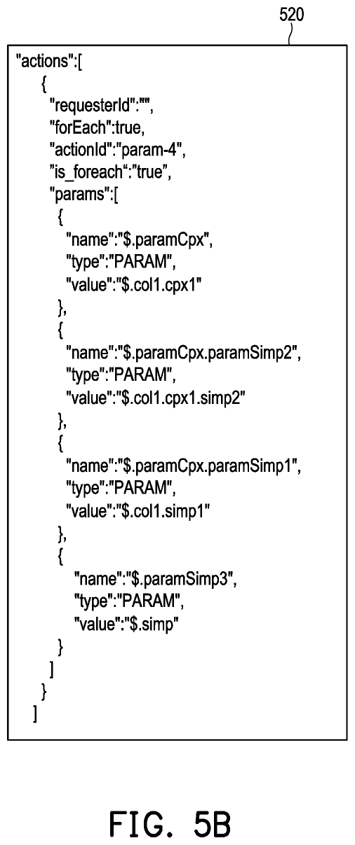

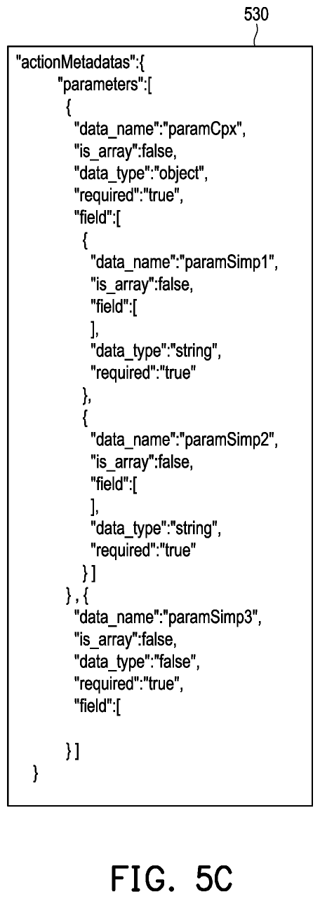

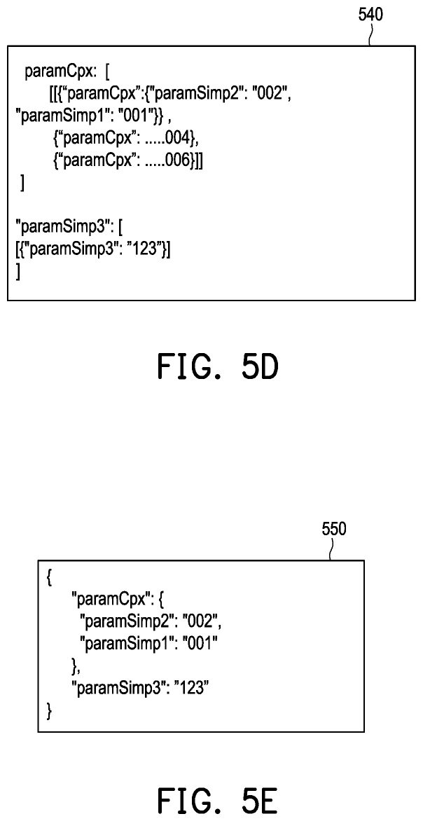

FIG. 4A to FIG. 4C are flowcharts of a data construction method according to an embodiment of the invention. Referring to FIG. 1, FIG. 3 and FIG. 4A to FIG. 4C, in the embodiment, the processor 111 of the data construction system 110 may execute the automatic construction component 311, the metadata set management unit 312, the data context management unit 313 and the service calling unit 314, and perform the following steps S401-S439 to realize the function of automatic data construction. Moreover, the following description is made by taking the JSON data structure as an example, but the invention is not limited thereto. Moreover, FIG. 5A to FIG. 5E is an example of generating an input parameter 550 according to a data source 510, but the invention is not limited thereto. The data construction system 110 and the data construction method of the invention may be used to realize application situations of using one data source to generate multiple input parameters, using multiple data sources to generate one input parameter, and using multiple data sources to generate multiple input parameters.

In the embodiment, the processor 111 may obtain the call request instruction 301 from the computer device 120. In step S401, the automatic construction component 311 may obtain the data source 510 shown in FIG. 5A and the input metadata 530 shown in FIG. 5C according to the call request instruction 301. In step S402, the automatic construction component 311 may obtain related source metadata from the data source 510. In step S403, the automatic construction component 311 may obtain a mapping rule 520 shown in FIG. 5B according to the metadata and the source metadata. The automatic construction component 311 may, for example, search for the corresponding mapping rule 520 according to the corresponding field (for example, “name”: “$.paramCpx”) based on the root key in the metadata. In step S404, the automatic construction component 311 may analyze the input metadata 530 to obtain a plurality of root key fields, such as “paramCpx” and “paramSimp3”.

In step S405, the automatic construction component 311 may construct each root key cyclically according to the input metadata 530. In step S406, the automatic construction component 311 may find out a source data field through the mapping rule 520 according to the root key fields. In step S407, the automatic construction component 311 may calculate how many layers there are in the data source 510. For example, for a first root key field “paramCpx”, the automatic construction component 311 may calculate 2 layers of set of $ to $.col1.cpx have. Moreover, for a second root key field “paramSimp3”, the automatic construction component 311 may calculate $.simp.

In the embodiment, the automatic build component 311 may execute the upward construction unit 3111. The upward construction unit 3111 may perform the following steps S408-S415. In step S408, the upward construction unit 3111 may determine whether all layers and elements of each layer have been constructed. If yes, the automatic construction component 311 may execute step S405. If not, in step S409, the upward construction unit 3111 may sequentially construct the outer structure of the root key according to a layer structure of the data source 510 (for example, in a direction from a root to a leaf), such as “cpx1”, “simp1”, etc. (i.e., to construct a key value in a key-value pair (key: value)). In step S410, the upward construction unit 3111 may determine whether all layers have been constructed. If not, in step S411, the upward construction unit 3111 may create a new complex structure for constructing an outer set of the current root key. If yes, the downward construction unit 3112 may execute step S416.

In step S412, the upward construction unit 3111 may calculate a current number of elements of the data source 510 to construct an inner structure of each element cyclically (i.e., construct a root value in the key-value pair (key: value)). In step S413, the upward construction unit 3111 may determine whether construction of all the elements of a current subsidiary layer is completed according to the constructed elements (for example, by element number judgement). If not, the upward construction unit 3111 may re-execute step S409 to construct the remaining layers. If yes, in step S414, the upward construction unit 3111 may determine that the construction of the current layer has been completed, and return to the previous layer to construct an inner structure of a next element of the previous layer. In step S415, the upward construction unit 3111 may put the structure completed in the current construction into an instance queue of the field, such as a current construction completion list 540 shown in FIG. 5D for subsequent merging and usage.

In the embodiment, the upward construction unit 3111 may execute step S405 and step S412 cyclically. For example, referring to the data source 510 shown in FIG. 5A and the current construction completion list 540 shown in FIG. 5D, when step S405 is executed for the first time, the upward construction unit 3111 may construct a root key corresponding to the root key field ‘paramCpx’. Then, the upward construction unit 3111 may cyclically execute the step S412 to sequentially construct a first element, a second element and a third element corresponding to the metadata “$.col1.cpx1”. Then, the upward construction unit 3111 may execute step S405 for the second time to construct a root key corresponding to the root key field “paramSimp3”.

In the embodiment, the automatic construction component 311 may execute the downward construction unit 3112. The downward construction unit 3112 may execute following steps S416-S424. In step S416, the downward construction unit 3112 may search for corresponding fields in the source data 510 according to the input metadata 530 and the mapping rule 520. In step S417, the downward construction unit 3112 may determine whether a structure described by an input metadata field is a complex set. If not, the downward construction unit 3112 may execute step S423. If yes, in step S418, the downward construction unit 3112 may analyze a source metadata field structure and calculate a number of elements in the structure. In step S419, the downward construction unit 3112 may determine whether all elements have been constructed. If not, in step S420, the downward construction unit 3112 may obtain a next element to construct the structure cyclically. In step S421, the downward construction unit 3112 may construct a complex structure. In step S422, the downward construction unit 3112 may cyclically construct all the fields in the complex structure, and then re-execute steps S416 and S417. When the downward construction unit 3112 determines that the structure described by the input metadata field is not a complex set, in step S423, the downward construction unit 3112 may further determine whether it is a complex structure. If yes, the downward construction unit 3112 executes step S422 again. If not, in step S424, the downward construction unit 3112 may search for the corresponding field on the data source 510 according to the mapping rule 520 and obtain a value, and then assign a value to the current field. In step S425, the downward construction unit 3112 may determine whether all fields of the complex structure have been constructed. If not, the downward construction unit 3112 executes step S422 again. If yes, in step S426, the downward construction unit 3112 may determine whether the current layer is already a layer of the root key. If not, the downward construction unit 3112 executes step S422 again. If yes, the upward construction unit 3111 may execute step S408. In addition, in step S424 and step S425, if the downward construction unit 3112 cannot obtain the value of the corresponding field, the downward construction unit 3112 may determine whether the value of the corresponding field is allowed to be null according to a description field “required” in the input metadata 530.

In step S405, when the upward construction unit 3111 determines that each root key has been cyclically constructed, the automatic construction component 311 may execute step S427 to determine a set layer number of the fields in all field lists to obtain the field with the most set layer number. The automatic build component 311 may execute the merging unit 3113. The merging unit 3113 may execute following steps S428-S439. In step S428, the merging unit 3113 may use the set layer number of the field as a cycle criterion. In step S429, the merging unit 3113 may perform recursion to enter the next layer.

For example, as shown in FIG. 5D, the merging unit 3113 may cyclically complete the first layer set according to the current construction completion list 540 to determine that the root key corresponding to the root key field “paramSimp3” has no more layer to continue the cycle, but the root key corresponding to the root key field “paramCpx” may continue to enter the second layer of the layers. At this time, since the second layer set corresponding to the root key field “paramCpx” and the complex structure corresponding to the root key field “paramSimp3” enter recursion together, the two fields have all obtained the complex structure containing the root key at this time. In this way, the two fields may be merged into one complex structure, and all of the structures and data under the two root key fields will be merged accordingly.

In step S430, the merging unit 3113 may determine whether there are fields that have encountered the root key, but other fields still have set structures that may be recursed. If yes, in step S431, the merging unit 3113 may pass in the complex structure containing the root key during recursion, and then continue to pass in the elements of the layers. If not, in step S432, the merging unit 3113 may cycle element referential numbers in the current layer to retrieve the corresponding element. In step S433, the merging unit 3113 may determine whether elements in all current layers are complex structures. If yes, in step S434, the merging unit 3113 may copy and merge the root key fields in the complex structures to a same complex structure. If not, the merging unit 3113 may execute step S436. In step S435, the merging unit 3113 may put the completed field set into the construction completion list. In step S438, the merging unit 3113 may convert the circular list into an expression of the corresponding sets in the output data structure.

In step S436, the merging unit 3113 may determine whether the current layer is already an initial layer, and the current layer has traversed to the last element. If not, the merging unit 3113 executes step S429 again. If yes, in step S437, the merging unit 3113 may determine whether circular calls are required in the mapping rule 520. If not, the merging unit 3113 executes step S438. If yes, in step S439, the merging unit 3113 may determine a final number of calls according to the number of elements in the current construction completion list 540, and use the list containing complex structures to represent multiple data as output.

For example, referring to the current construction completion list 540 of FIG. 5D and the input parameter 550 of FIG. 5E, the merging unit 3113 may merge data corresponding to the root key fields “paramCpx” and “paramSimp3” in the current construction completion list 540 to generate the input parameter 550.

Accordingly, the automatic construction component 311 may perform the above steps S401-S439 to automatically generate the input parameter 550 shown in FIG. 5 (i.e., the input parameter 302 in FIG. 3), and provide it to the service calling unit 314, so that the service calling unit 314 may send the input parameter 550 to the business system 140 to call the service of the corresponding API, and the service of the corresponding API may return corresponding business data to the computer device 120. In summary, the data construction system and data construction method of the invention are adapted to obtain the mapping rule and metadata set according to the call request instruction issued by the computer equipment at a client end, and may use the data source to automatically construct the corresponding input parameter according to the mapping rule and metadata set. The data construction system may automatically send the automatically constructed input parameter to the business system to call the service of the corresponding API, so that the corresponding API may return the corresponding business data to the computer device of the client end.

It will be apparent to those skilled in the art that various modifications and variations can be made to the disclosed embodiments without departing from the scope or spirit of the invention. In view of the foregoing, it is intended that the invention covers modifications and variations provided they fall within the scope of the following claims and their equivalents.

What is claimed is:

1. A data construction system, comprising:
a memory, configured to store a data automatic construction component; and
a processor, connected to a computer device, a server, and a business system, and configured to execute the data automatic construction component to obtain a call request instruction and a data source from the computer device,
wherein the data automatic construction component determines input metadata and an application programming interface to be called in the business system according to the call request instruction and the data source, and the data automatic construction component reads the server according to the application programming interface and the input metadata to obtain a mapping rule and a metadata set,
wherein the data automatic construction component uses the data source to construct an input parameter according to the mapping rule and the metadata set, and the data automatic construction component outputs the input parameter to the application programming interface, so that the application programming interface responds corresponding business data to the computer device according to the input parameter.

2. The data construction system according to claim 1, wherein the memory further stores:
a metadata set management unit, wherein the processor executes the metadata set management unit to manage the metadata set; and
a data context management unit, wherein the processor executes the data context management unit to manage context data provided by other application programming interfaces.

3. The data construction system according to claim 2, wherein the metadata set comprises metadata and source metadata, and the context data is a source data set.

4. The data construction system according to claim 2, wherein the data automatic construction component comprises an upward construction unit,
wherein the upward construction unit obtains the metadata set from the metadata set management unit according to the call request instruction, and obtains the context data from the data context management unit,
wherein the upward construction unit searches the server according to the application programming interface and the input metadata to obtain the mapping rule and the metadata set, and the upward construction unit constructs an outer structure corresponding to each of root key fields in the input parameter according to the mapping rule, the metadata set, the context data, and the input metadata.

5. The data construction system according to claim 4, wherein the data automatic construction component further comprises a downward construction unit,
wherein the downward construction unit constructs an inner structure corresponding to each of the root key fields in the input parameter according to the mapping rule, the metadata set, the context data, and the input metadata.

6. The data construction system according to claim 5, wherein the data automatic construction component further comprises a merging unit, and the merging unit merges all the root key fields to generate the input parameter.

7. The data construction system according to claim 6, wherein the memory further stores:
a service calling unit, wherein the processor executes the service calling unit to call the application programming interface to be called in the business system according to the input parameter.

8. The data construction system according to claim 1, wherein the call request instruction comprises an application programming interface name of the application programming interface to be called.

9. The data construction system according to claim 1, wherein the mapping rule is configured to represent a mapping relationship between data in the data source and a parameter structure of the input parameter.

10. The data construction system according to claim 1, wherein the input parameter is data of a form structure and comprises a plurality of fields.

11. A data construction method, comprising:
executing a data automatic construction component by a processor, and obtaining a call request instruction and a data source from a computer device;
determining input metadata and an application programming interface to be called in a business system by the data automatic construction component according to the call request instruction and the data source;
reading the server by the data automatic construction component according to the application programming interface and the input metadata to obtain a mapping rule and a metadata set;
using the data source by the data automatic construction component to construct an input parameter according to the mapping rule and the metadata set; and
outputting the input parameter to the application programming interface by the processor, so that the application programming interface responds corresponding business data to the computer device according to the input parameter.

12. The data construction method according to claim 11, further comprising:
executing a metadata set management unit by the processor to manage the metadata set; and
executing a data context management unit by the processor to manage context data provided by other application programming interfaces.

13. The data construction method according to claim 12, wherein the metadata set comprises metadata and source metadata, and the context data is a source data set.

14. The data construction method according to claim 12, wherein the data automatic construction component comprises an upward construction unit, wherein constructing the input parameter comprises:
obtaining the metadata set from the metadata set management unit by the upward construction unit according to the call request instruction, and obtaining the context data from the data context management unit,
searching the server by the upward construction unit according to the application programming interface and the input metadata to obtain the mapping rule and the metadata set; and
constructing an outer structure corresponding to each of root key fields in the input parameter by the upward construction unit according to the mapping rule, the metadata set, the context data, and the input metadata.

15. The data construction method according to claim 14, wherein the data automatic construction component further comprises a downward construction unit, wherein constructing the input parameter further comprises:
constructing an inner structure corresponding to each of the root key fields in the input parameter by the downward construction unit according to the mapping rule, the metadata set, the context data, and the input metadata.

16. The data construction method according to claim 15, wherein the data automatic construction component further comprises a merging unit, wherein constructing the input parameter further comprises:
merging all the root key fields by the merging unit to generate the input parameter.

17. The data construction method according to claim 16, wherein outputting the input parameter to the application programming interface comprises:
executing a service calling unit by the processor to call the application programming interface to be called in the business system according to the input parameter.

18. The data construction method according to claim 11, wherein the call request instruction comprises an application programming interface name of the application programming interface to be called.

19. The data construction method according to claim 11, wherein the mapping rule is configured to represent a mapping relationship between data in the data source and a parameter structure of the input parameter.

20. The data construction method according to claim 11, wherein the input parameter is data of a form structure and comprises a plurality of fields.
